(19) United States
(12) Patent Application Publication
(10) Pub. No.: US 2020/0234456 A1
(43) Pub. Date: Jul. 23, 2020

(54) IMAGE INSPECTION DEVICE, IMAGE FORMING SYSTEM, IMAGE INSPECTION METHOD, AND RECORDING MEDIUM

(71) Applicant: KONICA MINOLTA, INC., Tokyo (JP)

(72) Inventor: Mieko MITA, Hino shi, Tokyo (JP)

(73) Assignee: KONICA MINOLTA, INC., Tokyo (JP)

(21) Appl. No.: 16/737,254

(22) Filed: Jan. 8, 2020

(30) Foreign Application Priority Data
Jan. 22, 2019 (JP) 2019-008351

(51) Int. Cl. G06T 7/33; G06T 7/00

(52) U.S. Cl. CPC G06T 7/337; G06T 2207/30176; G06T 2207/30168; G06T 7/0004

(57) ABSTRACT

Disclosed is an image inspection device including: a hardware processor. The hardware processor performs: setting a first alignment region including a first feature point of a reference image; setting a second alignment region including a second feature point of an inspection image that is to be inspected, the image data being obtained by reading the inspection image on a recording medium with; transforming at least one of the reference image data and the inspection image data so as to reduce displacement between the first and second feature points; and comparing the reference image data and the inspection image data, wherein setting the first alignment region includes setting the first alignment region in the reference image excluding a specified first exclusion area, and wherein setting the second alignment region includes setting the second alignment region in the inspection image excluding a second exclusion area corresponding to the first exclusion area.

### CROSS-REFERENCE TO RELATED APPLICATIONS

The entire disclosure of Japanese Patent Application No. 2019-008351 filed on Jan. 22, 2019 is incorporated herein by reference in its entirety.

### BACKGROUND

### Technical Field

The present invention relates to an image inspection device, an image forming system, an image inspection method, and a recording medium.

### Description of the Related Art

There is an image inspection device that reads a recording medium on which an image to be inspected (hereinafter referred to as an inspection image) is formed, by using a reading device, compares obtained inspection image data with predetermined reference image data, and inspects the inspection image based on the comparison result. This type of image inspection device needs to accurately align the inspection image with the reference image before comparing the images, in order to remove the effect of displacement or inclination of a recording medium that is caused when reading the inspection image.

One known method of aligning an inspection image with a reference image is to specify a feature point, such as an edge portion of an image element (boundary between the regions with a large intensity difference) in each image, and perform image transformation processing, such as translation, magnification, reduction, and rotation, on either one of the images such that the position of the corresponding feature points of the images match (see, for example, Japanese Patent Application Publication No. 2001-357382).

### SUMMARY

However, in the case where an image is formed by variable data printing in which only a part of the image to be formed is changed for each recording medium, a feature point that does not match any feature point of a reference image is specified in a changed portion in an inspection image. Therefore, if alignment is performed using the above related-art method, inappropriate image transformation processing is performed that attempts to match the unmatched feature points, resulting in a reduction in alignment accuracy.

An object of the present invention is to provide an image inspection device, an image forming system, an image inspection method, and a recording medium that can minimize a reduction in accuracy of image alignment.

To achieve at least one of the abovementioned objects, according to an aspect of the present invention, an image inspection device reflecting one aspect of the present invention comprises: a hardware processor;

wherein the hardware processor performs:
setting a first alignment region including a first feature point of a reference image, based on reference image data of the reference image;
setting a second alignment region including a second feature point of an inspection image that is to be inspected, based on inspection image data obtained by a predetermined reading device reading a recording medium on which the inspection image is formed;
transforming at least one of the reference image data and the inspection image data so as to reduce displacement between the first feature point in the first alignment region and the second feature point in the second alignment region; and
comparing the reference image data and the inspection image data, after the transforming,

wherein setting the first alignment region includes setting the first alignment region in the reference image excluding a specified first exclusion area, and

wherein setting the second alignment region includes setting the second alignment region in the inspection image excluding a second exclusion area corresponding to the first exclusion area.

To achieve at least one of the abovementioned objects, according to another aspect of the present invention, an image inspection method reflecting one aspect of the present invention comprises:

setting a first alignment region including a first feature point of a reference image, based on reference image data of the reference image;

setting a second alignment region including a second feature point of an inspection image that is to be inspected, based on inspection image data obtained by a predetermined reading device reading a recording medium on which the inspection image is formed;

transforming at least one of the reference image data and the inspection image data so as to reduce displacement between the first feature point in the first alignment region and the second feature point in the second alignment region; and

comparing the reference image data and the inspection image data, after the transforming,

wherein setting the first alignment region includes setting the first alignment region in the reference image excluding a specified first exclusion area, and

wherein setting the second alignment region includes setting the second alignment region in the inspection image excluding a second exclusion area corresponding to the first exclusion area.

To achieve at least one of the abovementioned objects, according to another aspect of the present invention, a non-transitory recording medium reflecting one aspect of the present invention stores a computer-readable program that causes a hardware processor provided in an image inspection device to perform:

setting a first alignment region including a first feature point of a reference image, based on reference image data of the reference image;

setting a second alignment region including a second feature point of an inspection image that is to be inspected, based on inspection image data obtained by a predetermined reading device reading a recording medium on which the inspection image is formed;

transforming at least one of the reference image data and the inspection image data so as to reduce displacement between the first feature point in the first alignment region and the second feature point in the second alignment region; and

comparing the reference image data and the inspection image data, after the transforming,

wherein setting the first alignment region includes setting the first alignment region in the reference image excluding a specified first exclusion area, and

wherein setting the second alignment region includes setting the second alignment region in the inspection image excluding a second exclusion area corresponding to the first exclusion area.

### BRIEF DESCRIPTION OF THE DRAWING

The advantages and features provided by one or more embodiments of the invention will become more fully understood from the detailed description given hereinbelow and the appended drawings which are given by way of illustration only, and thus are no intended as a definition of the limits of the present invention, wherein:

FIG. 1 illustrates the schematic configuration of an image forming system;

FIG. 2 is a schematic diagram illustrating the configuration of an inline scanner;

FIG. 3 illustrates the flow of a recording medium and data in the image forming system, and the configuration of an image inspection device;

FIG. 4 illustrates an example of recording media on which variable data printing is performed;

FIG. 5 is a diagram for explaining the overview of an image inspection method performed by the image inspection device;

FIG. 6 illustrates an example of a reference data image in which temporary alignment regions are set;

FIG. 7A illustrates an example of an exclusion setting screen;

FIG. 7B illustrates the example of an exclusion setting screen;

FIG. 8 illustrates a user input that specifies an exclusion area on the exclusion setting screen;

FIG. 9 is a flowchart illustrating the control steps of image inspection processing;

FIG. 10 illustrates a user input that specifies an exclusion area according to Modification 2;

FIG. 11 illustrates an example of an exclusion setting screen according to a second embodiment; and

FIG. 12 is a flowchart illustrating the control steps of image inspection processing according to the second embodiment.

### DETAILED DESCRIPTION OF THE EMBODIMENTS

Hereinafter, embodiments of an image forming device and an image forming method of the present invention will be described with reference to the accompanying drawings. However, the scope of the invention is not limited to the disclosed embodiments.

### First Embodiment

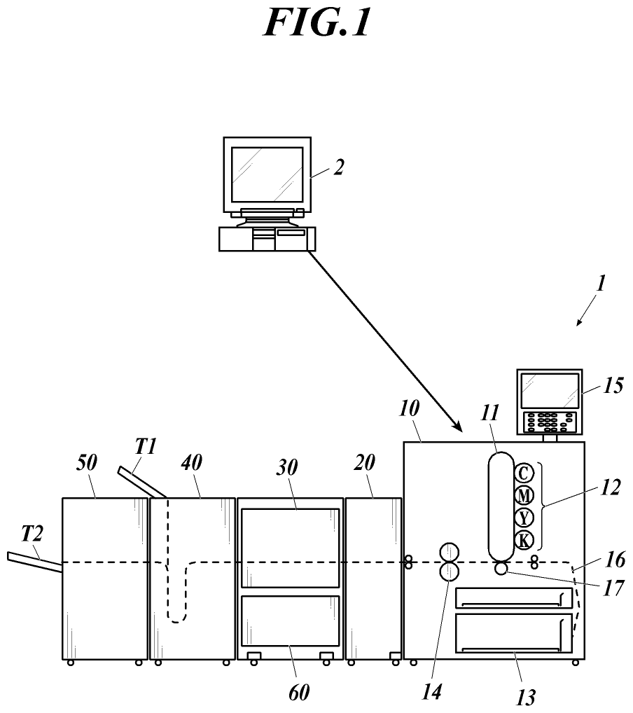

FIG. 1 illustrates the schematic configuration of an image forming system 1 according to an embodiment of the present invention.

The image forming system 1 includes an image forming device 10, a relay unit 20, an inline scanner 30 (reading device), a purge unit 40, a finisher 50, and an image inspection device 60.

The image forming device 10 receives print data (bitmap data generated by a raster image processor (RIP) in this example) from an external device 2, and forms (prints) an image on a recording medium based on the print data. The image forming device 10 includes an intermediate transfer belt 11, an image forming unit 12, a sheet feed tray 13, a fixing device 14, a display 15 (display device), a conveyance path 16, and a transfer roller 17.

The intermediate transfer belt 11 is an endless belt member extending around a plurality of rollers to circulate.

The image forming unit 12 is disposed along the intermediate transfer belt 11, and forms toner images of cyan (C), magenta (M), yellow (Y), and black (K) on the intermediate transfer belt 11, based on the print data.

The sheet feed tray 13 stores recording media on which an image is to be formed. The recording media that may be used include recording media of various materials on which toner can be fixed, such as paper and resin sheets. A recording medium stored in the sheet feed tray 13 is conveyed along the conveyance path 16 passing through a nip between the intermediate transfer belt 11 and the transfer roller 17, and the fixing device 14. When the recording medium passes through the nip between the intermediate transfer belt 11 and the transfer roller 17, toner images are transferred to the recording medium, so that an image is formed.

The fixing device 14 fixes toner on the recording medium, by heating and pressing the recording medium while holding the recording medium between a pair of fixing rollers.

The display 15 includes a liquid crystal display (LCD), an electro luminescence (EL) display, or the like, and displays various information such as the operation status of the image forming system 1 and the processing result.

The image forming device 10 sends the recording medium with the image formed thereon to the relay unit 20. The image forming device 10 is not limited to those of the tandem-type electrophotographic system described above, and any system may be used to form an image on a recording medium.

The relay unit 20 conveys the recording medium received from the image forming device 10, and sends the recording medium to the inline scanner 30 at the downstream side thereof.

The inline scanner 30 conveys the recording medium received from the relay unit 20, scans (images) both sides of the recording medium being conveyed so as to optically read the images on both sides of the recording medium, and outputs image data of the reading result to the image inspection device 60. The inline scanner 30 sends the recording medium that has been read to the purge unit 40 at the downstream side thereof.

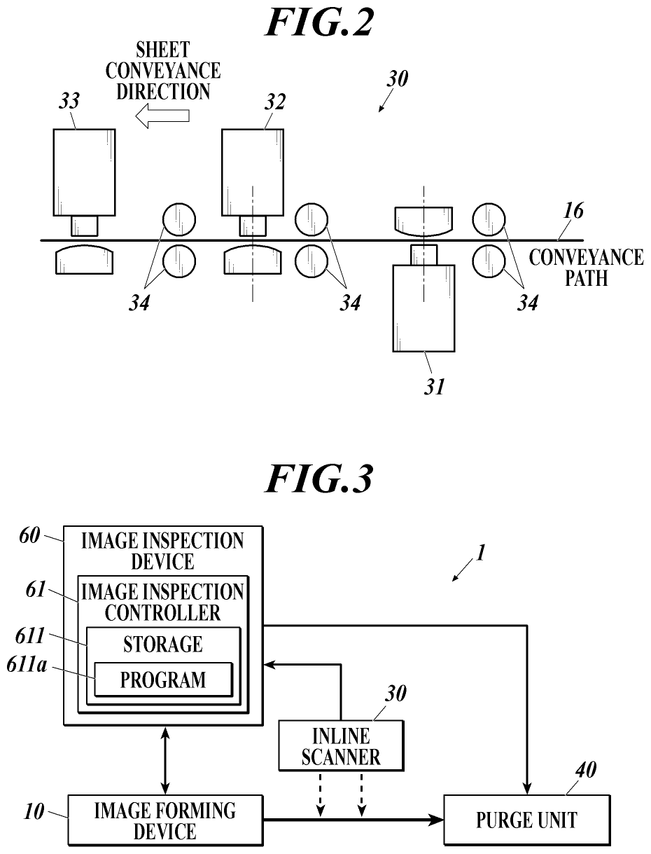

FIG. 2 is a schematic diagram illustrating the configuration of the inline scanner 30.

The inline scanner 30 includes a lower-side line image sensor 31 that reads the back side (lower side) of the recording medium, an upper-side line image sensor 32 that reads the front side (upper side) of the recording medium, and a colorimeter 33 that measures the color of the recording medium, which are disposed at different positions in the conveyance direction of the recording medium. Further, conveyance rollers 34 for conveying the recording medium are disposed upstream and downstream of the lower-side line image sensor 31 and the upper-side line image sensor 32.

Since the inline scanner 30 is configured such that the lower-side line image sensor 31 and the upper side line image sensor 32 are arranged along the conveyance path 16 of the recording medium, it is possible to read both sides of the recording medium during a single pass.

The lower-side line image sensor 31 and the upper-side line image sensor 32 read a reading area extending in a width direction orthogonal to the conveyance direction, at a predetermined reading position on the conveyance path 16. The lower-side line image sensor 31 and the upper-side line image sensor 32 repeatedly perform an operation of reading the recording medium passing through the reading area so as to two-dimensionally read the whole surface of the recording medium.

The reading width of the lower-side line image sensor 31 and the upper-side line image sensor 32 in the width direction is set greater than the width of the recording medium such that the inline scanner 30 reads the area containing the recording medium and the background portion therearound (a predetermined area outside the longitudinal edges and lateral edges thereof). The background portion around the recording medium is read as black.

The purge unit 40 conveys the recording medium received from the inline scanner 30, and sends the recording medium to the finisher 50 at the downstream side thereof. The purge unit 40 sorts the recording medium on which an image abnormality is detected by the image inspection device 60 (described below) into a first sheet discharge tray T1.

The finisher 50 performs specified post-processing on the recording medium received from the purge unit 40, and then discharges the recording medium to a second sheet discharge tray T2.

The image inspection device 60 inspects (checks) whether an image formed on each recording medium is normal, based on the reading result of the image on the recording medium by the inline scanner 30.

FIG. 3 illustrates the flow of a recording medium and data in the image forming system 1, and the configuration of the image inspection device 60. In FIG. 3, the thin solid line indicates the flow of data, whereas the bold solid line indicates the flow of a recording medium.

A recording medium with an image formed thereon by the image forming device 10 is conveyed to the purge unit 40. While being conveyed, both sides of the recording medium and its surrounding background are read by the inline scanner 30. The inline scanner 30 outputs image data obtained by reading the recording medium to the image inspection device 60.

The image inspection device 60 includes an image inspection controller 61 (hardware processor). The image inspection controller 61 includes a central processing unit (CPU) (not illustrated), a random access memory (RAM) (not illustrated), and a storage 611 (non-transitory recording medium), and performs various types of processing for image inspection as the CPU operates according to a program 611a stored in the storage 611. Also, as the CPU operates according to the program 611a, the image inspection controller 61 performs first setting processing, second setting processing, image transformation processing, comparison processing, temporary setting processing, first input processing, second input processing, and display control processing.

The image inspection device 60 inspects an image based on the image data output from the inline scanner 30, and outputs the inspection result data to the purge unit 40.

The purge unit 40 determines whether to discharge the recording medium to the first sheet discharge tray T1 or to the finisher 50, based on the inspection result data received from the image inspection device 60. More specifically, the purge unit 40 discharges the recording medium to the first sheet discharge tray T1 if an abnormality is detected in the image formed thereon. On the other hand, the purge unit 40 sends the recording medium to the finisher 50 if the image formed thereon is determined to be normal.

In the image forming system 1 of the present embodiment, the image forming device 10 can perform variable data printing in which only a part of the image to be formed is changed for each recording medium. In the following description, the region of an image on a recording medium containing the content that is changed for each recording medium in variable data printing is referred to as a “variable region”, and the region containing the content common to each recording medium is referred to as a “common region”.

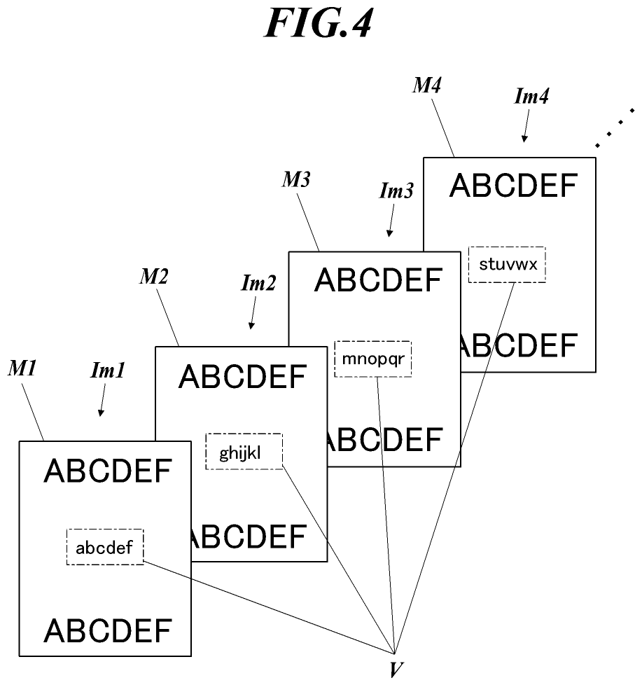

FIG. 4 illustrates an example of recording media on which variable data printing is performed.

In FIG. 4, an image Im1 is formed on a first recording medium M1; an image Im2 is formed on a second recording medium M2; an image Im3 is formed on a third recording medium M3; and an image Im4 is formed on a fourth recording medium M4.

The images Im1 to Im4 are the same in that the text “ABCDEF” is included at each of the upper and lower ends, but are different in the content of a variable region V at the center, in which the content is changed for each recording medium. Specifically, the image Im1 includes the text “abcdef” in its variable region V; the image Im2 includes the text “ghijkl” in its variable region V; the image Im3 includes the text “mnopqr” in its variable region V; and the image Im4 includes the text “stuvwx” in its variable region V.

Examples of the method of processing print data for performing variable data printing may include, but not limited to, a method that performs processing for combining the data for the variable region with the data for the common region when generating print data using a RIP in the external device 2.

In the following, the image inspection method performed by the image inspection device 60 will be described.

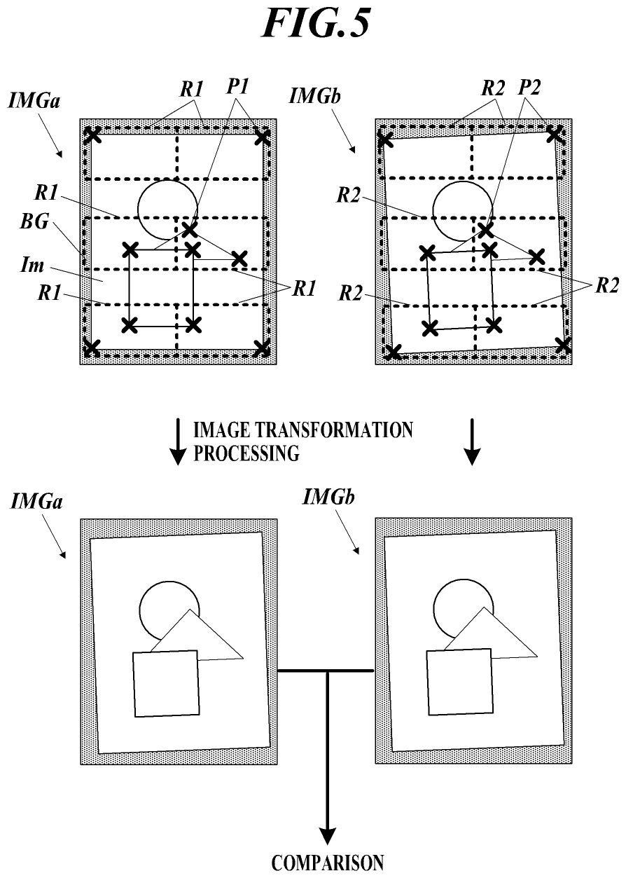

FIG. 5 is a diagram for explaining the overview of an image inspection method performed by the image inspection device 60.

In an inspection of images by the image inspection device 60, an image formed on a first recording medium is used as a reference image, and images formed on a second and subsequent recording media are images to be inspected (hereinafter referred to as inspection images). Then, each inspection image is compared with the reference image, and an abnormality of the inspection image is detected if there is a difference exceeding a predetermined reference level.

The reference image does not have to be the image formed on the first recording medium. A sample image formed on another predetermined recording medium may be used as a reference image.

Specifically, when the image inspection device 60 starts an image inspection, the first recording medium with an image formed thereon is first read by the inline scanner 30, and the obtained image data is acquired as a reference data image IMGa.

Also, each of the second and subsequent recording media is sequentially read by the inline scanner 30, and the obtained image data is acquired as an inspection data image IMGb.

In FIG. 5, an image of the reference image data is illustrated as the reference data image IMGa, and an image of the inspection image data is illustrated as the inspection data image IMGb. Each of the reference data image IMGa and the inspection data image IMGb includes a portion corresponding to an image Im formed on the recording medium, and a portion corresponding to a background BG around the recording medium. In FIG. 5, the black background BG is represented in a neutral color for clarification of the drawing.

The obtained reference image data is analyzed, so that first feature points P1 in the reference image are specified. Then, first alignment regions R1 of a predetermined shape respectively including the first feature points P1 are set in the reference data image IMGa. Similarly, each inspection image data is analyzed, so that second feature points P2 in the inspection image are specified. Then, second alignment regions R2 of a predetermined shape respectively including the second feature points P2 are set in the inspection data image IMGb. The size of the first alignment region R1 and the second alignment region R2 is less than or equal to one-fourth of the size of the recording medium.

In the following description, each of the first feature point P1 and the second feature point P2 is simply referred to as a “feature point P” when there is no need to distinguish them. Also, each of the first alignment region R1 and the second alignment region R2 is simply referred to as an “alignment region R” when there is no need to distinguish them.

Data representing the first alignment region R1 and data representing the first feature point P1 in that region in FIG. 5 form first position model data. Also, data representing the second alignment region R2 and data representing the second feature point P2 in that region form second position model data. In the following description, each of the first position model data and the second position model data is simply referred to as “position model data” when there is no need to distinguish them.

The position model data includes data of the coordinates indicating the position and range of the alignment region R (for example, data representing the positions of the opposing corners of the rectangular region), and data of the coordinates indicating the feature point P.

The feature point P is selected from the edge portion of an image element (boundary between the regions with a large intensity difference), for example.

Examples of the method of specifying an edge portion may include, but not limited to, the following method. First, a small window of N pixels×M pixels (N≥3, M≥3) is selected in the image data, and the gradation of the pixels in the small window is binarized using a predetermined intermediate gradation as a threshold. If there is a difference in gradation between the center pixel and a peripheral pixel in the small window, the center pixel of the small window is extracted as a candidate for the edge portion. Then, the above processing is performed while shifting the small window one pixel by one pixel and selecting (scanning) the small window. If there are a predetermined number or more of consecutive candidate pixels for the edge portion, these candidate pixels can be specified as the edge portion.

The edges (for example, the four corners) of the recording medium may be used as feature points P. Since the edges of the recording medium may be used as feature points P, it is possible to specify a feature point P and perform alignment and inspection of the image even when no edge portion can be specified from the image element (such as when the recording medium is blank).

In FIG. 5, both the feature points P at the edge portions in the image and the feature points P at the corners of the recording medium are used, it may be so configured that the feature points P at the corners of the recording medium are used only if there is no image element or if no edge portion can be specified from the image element.

As described above, at least one piece of first position model data is generated for the reference data image IMGa, and at least one piece of second position model data is generated for the inspection data image IMGb. Since the reference image and the inspection image are the same image, the same number of pieces of position model data are generated at the corresponding positions for each of the reference data image IMGa and the inspection data image IMGb.

It is preferable that pieces of position model data are generated such that the alignment regions R are arranged at the four corners of each of the reference data image IMGa and the inspection data image IMGb. This can further improve the alignment accuracy described below.

The first position model data is generated only once when the reference image is read, whereas the second position model data is generated each time an inspection image is read (i.e., for each recording medium).

After the position model data is generated for each of the reference data image IMGa and the inspection data image IMGb, the amount of displacement (distance, the degree of misalignment) between the feature points P is calculated based on the first position model data of the reference data image IMGa and the corresponding second position model data of the inspection data image IMGb. That is, the amount of displacement between the first feature point P1 in the first alignment region R1 and the second feature point P2 in the second alignment region R2 disposed at the position corresponding to the first alignment region R1 is calculated for each first alignment region R1. Then, image transformation processing is performed on the reference image data so as to eliminate (or reduce) the displacement between the first feature point P1 and the second feature point P2. Specifically, image transformation including translation, increasing the size, reducing the size, and rotation (e.g., affine transformation) is performed.

As a result, as illustrated on the lower side of FIG. 5, the reference data image IMGa and the inspection data image IMGb are aligned. In the example of FIG. 5, the inspection data image IMGb is inclined with respect to the reference data image IMGa due to the displacement of the recording medium at the time of reading. Accordingly, image transformation processing for correcting the displacement between the feature points P is performed, so that the reference data image IMGa is rotated to have the same inclination angle as the inspection data image IMGb.

After performing the alignment described above, the reference image data and the inspection image data are compared. Accordingly, even if the recording medium is displaced or inclined, it is possible to appropriately detect an abnormality (such as smudge and printing defect) of the inspection image based on the difference between the reference image data and the inspection image data.

In the following, the inspection method for images formed by variable data printing will be described.

In the case where variable data printing illustrated in FIG. 4 is performed as well, the image Im1 of the first recording medium M1 is used as the reference image, and the images Im2, Im3, Im4, and so on of the second and subsequent recording media are used as the inspection images.

As mentioned above, the images Im2, Im3, Im4 and so on differ from the image Im1 formed on the first recording medium M1 in the content of the variable region V. Therefore, as for the area including the variable region V, the second feature point P2 is specified at the position not corresponding to the first feature point P1 in the first alignment region R1 set based on the reference image data, in the second alignment region R2 set based on the inspection image data. Accordingly, if alignment is performed by simply using the above method, inappropriate image transformation processing is performed that attempts to match the unmatched feature points P in the variable region V, resulting in a reduction in alignment accuracy.

In view of the above, according to the image inspection device 60 of the present embodiment, the first alignment region R1 is set in the area excluding the area (first exclusion area) that includes the variable region V, in the reference data image IMGa. Similarly, the second alignment region R2 is set in the area excluding the area (second exclusion area corresponding to the first exclusion area) that includes the variable region V, in the inspection data image IMGb. As a result, no feature point P is specified in the variable region V, and hence no alignment region R is set (i.e., no position model data is generated) therein. Accordingly, the reduction in alignment accuracy described above can be prevented.

Specifically, when the image inspection device 60 starts an image inspection, the first recording medium M1 with an image formed thereon is first read by the inline scanner 30, so that reference image data is acquired. Then, with the same method as the method of setting the first alignment region R1 described above, temporary alignment regions r are first set in the reference data image IMGa.

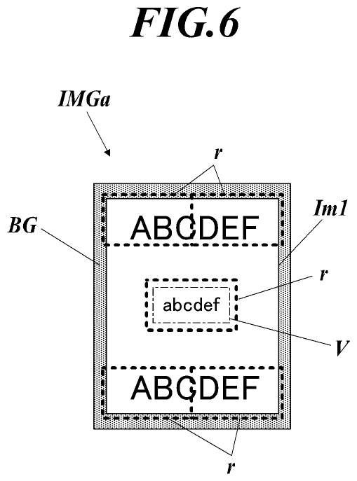

FIG. 6 illustrates an example of the reference data image IMGa in which the temporary alignment regions r are set.

As illustrated in FIG. 6, a plurality of temporary alignment regions r each including a first feature point P1 (not illustrated in FIG. 6) are set in the reference data image IMGa. In this example, four temporary alignment regions r are set near the four corners of the reference data image IMGa, and a temporary alignment region r is also set in the area including the variable region V at the center.

After the plurality of temporary alignment regions r are set, the display 15 displays an exclusion setting screen 70 containing the reference data image IMGa and the set plurality of temporary alignment regions r. Then, the exclusion setting screen 70 receives a user input that specifies the temporary alignment region r to be excluded so as not to be set as a first alignment region R1, from among the plurality of temporary alignment regions r.

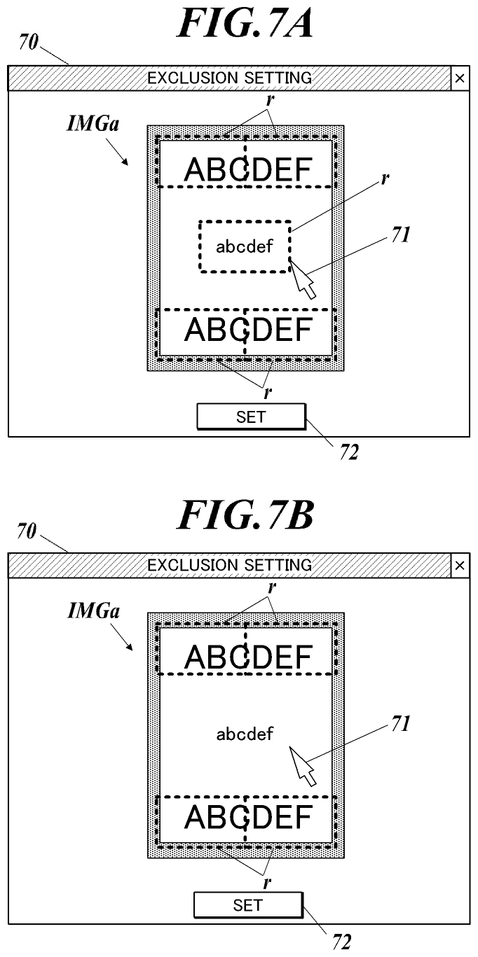

FIGS. 7A and 7B illustrate an example of the exclusion setting screen 70.

The exclusion setting screen 70 displays the reference data image IMGa, the plurality of temporary alignment regions r, a pointer 71, and a set button 72.

The user operates the pointer 71 by using an input device, such as a mouse and a touch panel, so as to make a user input (e.g., clicking the mouse button, and tapping the touch panel) that selects a desired temporary alignment region r. By doing so, the user can specify the temporary alignment region r as a temporary alignment region r to be excluded. For example, a user input is made that selects the temporary alignment region r at the center that includes the variable region V, while the pointer 71 is placed on that temporary alignment region r as illustrated in FIG. 7A. Then, as illustrated in FIG. 7B, the temporary alignment region r is specified to be excluded, and hence is deleted from the screen. A user input that selects a temporary alignment region r to be excluded as described above corresponds to a first user input. Further, the area of the temporary alignment region r specified to be excluded corresponds to a first exclusion area.

When a user input that selects the set button 72 is made in the state illustrated in FIG. 7B, the temporary alignment region r to be excluded is fixed.

When setting a temporary alignment region r to be excluded, only a first user input that specifies a temporary alignment region r including only a point other than the edge of the recording medium as a feature point P may be received. In other words, a temporary alignment region r including an edge of the recording medium as a feature point P may be prevented from being specified to be excluded. The method for realizing this is not especially limited. For example, on the exclusion setting screen 70, a user input that selects a temporary alignment region r including an edge of the recording medium as a feature point P may be disabled, or the temporary alignment region r including an edge of the recording medium as a feature point P may be hidden in advance.

In this manner, even when no feature point P can be specified from an image element (such as when the recording medium is blank), alignment and inspection of the image can be performed using the feature point P set at the edge of the recording medium.

When the temporary alignment region r to be excluded is specified, the temporary alignment regions r excluding the specified temporary alignment region r are set as first alignment regions R1 in the reference data image IMGa.

Meanwhile, in the inspection data image IMGb, the second alignment regions R2 are set at the positions corresponding to the respective first alignment regions R1. Accordingly, the second alignment regions R2 are set in the area excluding the second exclusion area corresponding to the first exclusion area, in the inspection data image IMGb.

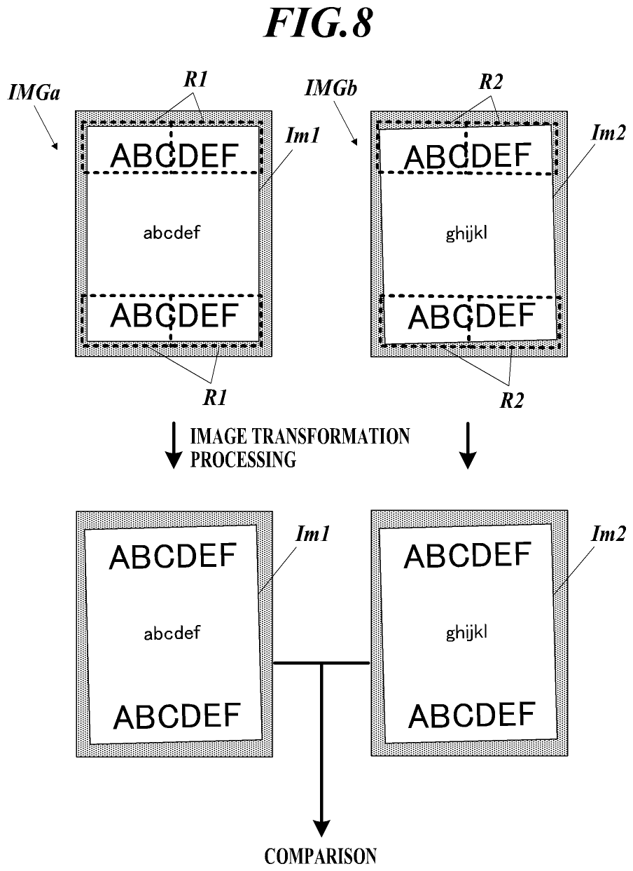

FIG. 8 illustrates an inspection of the image based on the alignment regions R that are set as described above.

As illustrated in FIG. 8, in each of the reference data image IMGa and the inspection data image IMGb, the alignment regions R are set at the four corners in the area excluding the variable region V at the center, and the amount of displacement is calculated for the feature point P (not illustrated in FIG. 8) in the image element (in this example, the text “ABCDEF”) in each of these alignment regions R. That is, as for the image element in the variable region V, no feature point P is specified, so that calculation of the amount of displacement is not performed.

Then, image transformation processing is performed on the reference image data so as to eliminate (or reduce) the displacement between the feature points P. As a result, as illustrated on the lower side of FIG. 8, the reference data image IMGa and the inspection data image IMGb are aligned.

After completion of the alignment, the reference image data and the inspection image data are compared, and an abnormality of the inspection image is detected based on the comparison result. Since the reference image data and the inspection image data differ in the content of the variable region V, an abnormality of the inspection image is detected based on the comparison result of the region excluding the variable region V.

In the following, image inspection processing for inspecting an image using the above method will be described.

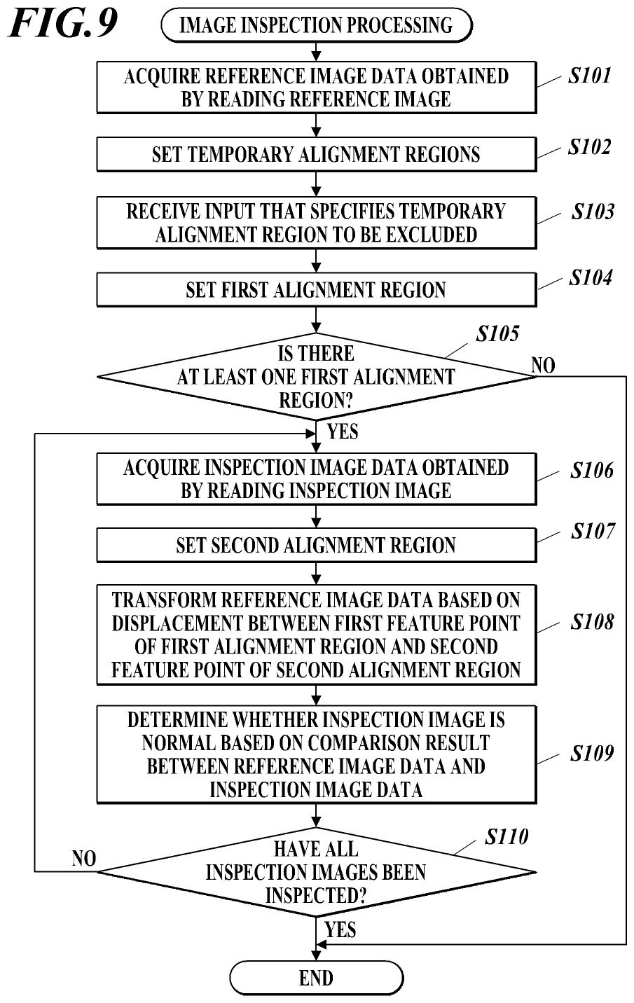

FIG. 9 is a flowchart illustrating the control steps of image inspection processing by the image inspection controller 61.

When image inspection processing starts, the image inspection controller 61 acquires reference image data that is obtained by reading a reference image formed on a first recording medium M1, using the inline scanner 30 (step S101).

The image inspection controller 61 sets temporary alignment regions r, based on the reference image data, using the above method (step S102: temporary setting processing).

The image inspection controller 61 causes the display 15 to display the exclusion setting screen 70, and receives a user input that specifies the temporary alignment region r to be excluded (step S103: first input processing).

When the temporary alignment region r to be excluded is fixed, the image inspection controller 61 sets each of the temporary alignment regions r excluding the specified temporary alignment region r, as a first alignment region R1 (step S104).

Steps S102 to S104 correspond to first setting processing and a first setting step.

The image inspection controller 61 determines whether at least one first alignment region R1 is set (step S105). If no first alignment region R1 is set (“NO” in step S105), the image inspection processing is terminated. In this case, image inspection for each recording medium is not performed.

If at least one first alignment region R1 is set (“YES” in step S105), the image inspection controller 61 acquires inspection image data obtained by reading an inspection image formed on each of the second and subsequent recording media, using the inline scanner 30 (step S106).

The image inspection controller 61 sets a second alignment region R2 at a position corresponding to the first alignment region R1 that is set in step S104 (step S107: second setting processing, second setting step).

The image inspection controller 61 calculates the displacement between a first feature point P1 of the first alignment region R1 and a second feature point P2 of the second alignment region R2, and performs image transformation processing on the reference image data so as to eliminate the displacement (step S108: image transformation processing, image processing step).

The image inspection controller 61 determines whether the inspection image is normal, based on the result of comparison between the reference image data and the inspection image data, and outputs the inspection result data to the purge unit 40 (step S109: comparison processing, comparison step)

The image inspection controller 61 determines whether all the inspection images have been inspected (step S110). If any of the inspection image has not been inspected (“NO” in step S110), the process returns to step S106.

If all the inspection images have been inspected (“YES” in step S110), the image inspection processing ends.

In the following, modifications of the above embodiment will be described.

(Modification 1)

In the above embodiment, image data obtained by reading the recording medium M1 with the reference image formed thereon using the inline scanner 30 is used as the reference image data. However, the reference data is not limited thereto. Image data (bitmap data) generated by a RIP for the image forming device 10 to form the reference image may be used as the reference image data.

(Modification 2)

The user input (first user input) for specifying the temporary alignment region r on the exclusion setting screen 70 is not limited to that illustrated in FIGS. 7A and 7B.

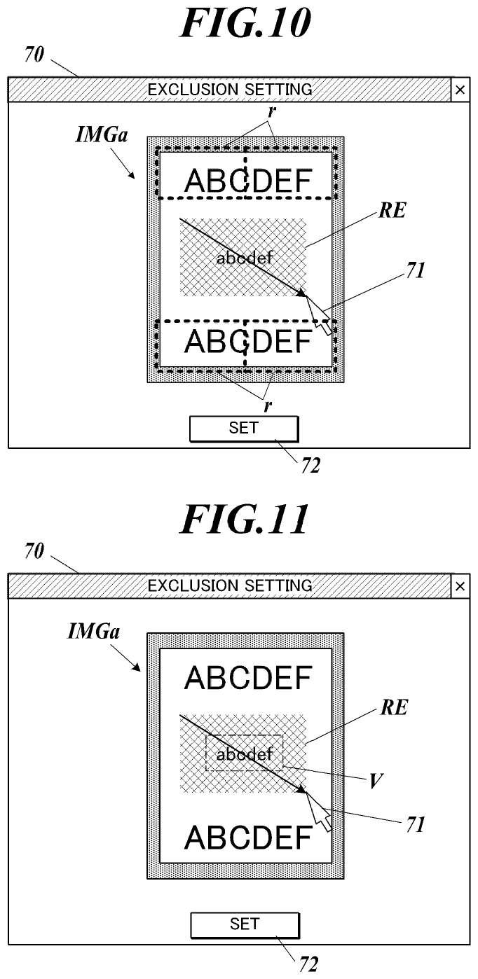

For example, as illustrated in FIG. 10, a rectangular area forming a part of the reference data image IMGa may be selected as an exclusion area RE (first exclusion area) by dragging the pointer 71. In this manner, a temporary alignment region r included in the exclusion area RE may be specified to be excluded.

As described above, the image inspection device 60 according to the first embodiment includes the image inspection controller 61, wherein the image inspection controller 61 is configured to perform: first setting processing that sets a first alignment region R1 including a first feature point P1 for a reference image, based on reference image data of the reference image; second setting processing that sets a second alignment region R2 including a second feature point P2 for an inspection image that is to be inspected, based on inspection image data obtained by reading a recording medium on which the inspection image is formed, using the inline scanner 30; image transformation processing on at least either the reference image data or the inspection image data to reduce displacement between the first feature point P1 in the first alignment region R1 and the second feature point P2 in the second alignment region R2; and comparison processing that compares the reference image data and the inspection image data, after performing the image transformation processing. The first setting processing includes setting the first alignment region R1 in an area excluding a specified exclusion area RE (first exclusion area) in a reference data image IMGa of the reference image data, and the second setting processing includes setting the second alignment region R2 in an area excluding an exclusion area (second exclusion area) corresponding to the exclusion area RE, in an image of the inspection image data.

With this configuration, if an area of the inspection image is determined in advance to be an area where a feature point P cannot be specified at the position corresponding to the reference image, the area is specified as the exclusion area RE. This prevents inappropriate image transformation processing that attempts to match the unmatched feature points from being performed. Accordingly, it is possible to effectively prevent a reduction in accuracy of image alignment. Therefore, even when an image is formed by variable data printing, it is possible to perform image alignment with high accuracy, and appropriately inspect the image.

The image inspection controller 61 is configured to further perform temporary setting processing that sets a plurality of temporary alignment regions r each including the first feature point P1, based on the reference image data, and first input processing that receives a first user input that specifies at least one of the plurality of temporary alignment regions r as a temporary alignment region r to be excluded; and the first setting processing includes setting each of the plurality of temporary alignment regions r excluding the temporary alignment region r specified by the first user input, as the first alignment region R1. Accordingly, the intended first alignment region R1 (and the second alignment region R2 corresponding thereto) can be accurately excluded.

The image inspection controller 61 is configured to further perform display control processing that causes the display 15 to display the reference data image IMGa and the plurality of temporary alignment regions r, and the first user input includes a user input that selects at least one of the plurality of temporary alignment regions r displayed on the display 15. Accordingly, the intended first alignment region R1 (and the second alignment region R2 corresponding thereto) can be accurately excluded, by an intuitive and simple user input that selects the temporary alignment region r in the reference data image IMGa.

According to Modification 2, the first user input includes a user input that specifies the temporary alignment region r included in the exclusion area RE, by selecting a part of the reference data image IMGa displayed on the display 15 as the exclusion area RE. Accordingly, the intended first alignment region R1 (and the second alignment region R2 corresponding thereto) can be accurately excluded, by an intuitive and simple user input that selects the exclusion area RE in the reference data image IMGa.

The second setting processing includes setting the second alignment region R2 at the position corresponding to the first alignment region R1. Accordingly, the second alignment region R2 corresponding to the first alignment region R1 can easily be set.

The reference image data is image data obtained by reading a recording medium on which the reference image is formed, using the inline scanner 30. Accordingly, the reference image data can easily be obtained.

The reference image data is image data of an area including an edge of the recording medium, and the first input processing receives the first user input that specifies the temporary alignment region r including only a point other than the edge of the recording medium as the first feature point P1. Accordingly, even when no feature point P can be specified from an image element (e.g., if the recording medium is blank), alignment and inspection of the image can be performed using the feature point P set at the edge of the recording medium.

The reference image data may be image data generated by a RIP for the image forming device 10 to form the reference image on a recording medium. Thus, the reference image data can easily be obtained by using the image data used for forming the reference image.

Further, the image forming system 1 of the present embodiment includes the image forming device 10 that forms an image on a recording medium, the inline scanner 30 that reads the image formed on the recording medium, and the image inspection device described above. Accordingly, it is possible to effectively prevent a reduction in accuracy of image alignment.

The image inspection method according to the present embodiment includes: a first setting step of setting a first alignment region R1 including a first feature point P1 for a reference image, based on reference image data of the reference image; a second setting step of setting a second alignment region R2 including a second feature point P2 for an inspection image that is to be inspected, based on inspection image data obtained by reading a recording medium on which the inspection image is formed, using the predetermined inline scanner 30; an image transformation processing step of performing image transformation processing on at least either the reference image data or the inspection image data to reduce displacement between the first feature point P1 in the first alignment region R1 and the second feature point P2 in the second alignment region R2; and a comparison step of comparing the reference image data and the inspection image data, after performing the image transformation processing; wherein the first setting step includes setting the first alignment region R1 in an area excluding a specified exclusion area RE (first exclusion area) in a reference data image IMGa of the reference image data; and wherein the second setting step includes setting the second alignment region R2 in an area excluding an exclusion area (second exclusion area) corresponding to the exclusion area RE, in an image of the inspection image data. With this method, it is possible to effectively prevent a reduction in accuracy of image alignment.

The storage unit 611 according to the present embodiment is a non-transitory recording medium storing the computer-readable program 611a, the program 611a causing the image inspection controller 61 serving as a computer provided in the image inspection device 60 to perform: first setting processing that sets a first alignment region R1 including a first feature point P1 for a reference image, based on reference image data of the reference image; second setting processing that sets a second alignment region R2 including a second feature point P2 for an inspection image that is to be inspected, based on inspection image data obtained by reading a recording medium on which the inspection image is formed, using the inline scanner 30; image transformation processing on at least either the reference image data or the inspection image data to reduce displacement between the first feature point P1 in the first alignment region R1 and the second feature point P2 in the second alignment region R2; and comparison processing that compares the reference image data and the inspection image data, after performing the image transformation processing; wherein first setting processing includes setting the first alignment region R1 in an area excluding a specified exclusion area RE (first exclusion area) in a reference data image IMGa of the reference image data; and the second setting processing includes setting the second alignment region R2 in an area excluding an exclusion area (second exclusion area) corresponding to the exclusion area RE, in an image of the inspection image data. By operating the image inspection device 60 according to the program 611a, it is possible to effectively prevent a reduction in accuracy of image alignment.

### Second Embodiment

In the following, a second embodiment of the present invention will be described. The present embodiment is different from the first embodiment in that a user input (second user input) that specifies an exclusion area RE (first exclusion area) in a reference data image IMGa in advance is received, and a first alignment region R1 is set in the area excluding the specified exclusion area RE. The following description focuses the differences from the first embodiment.

FIG. 11 illustrates an example of an exclusion setting screen 70 according to the second embodiment.

In the present embodiment, when reference image data is acquired, the exclusion setting screen 70 is displayed on the display 15 without setting the temporary alignment region r. Accordingly, the exclusion setting screen 70 displays the reference data image IMGa, but does not display any temporary alignment region r.

On the exclusion setting screen 70, a rectangular area forming a part of the reference data image IMGa may be selected by dragging the pointer 71. In this manner, the rectangular area can be selected as an exclusion area RE. When a user input that selects the set button 72 is made while the exclusion area RE is specified, the exclusion area RE is fixed.

After the exclusion area RE is fixed, the first alignment region R1 is set in the area excluding the exclusion area RE in the reference data image IMGa.

The subsequent operations are the same as those of the first embodiment.

In this embodiment as well, a temporary alignment region r including an edge of the recording medium as a feature point P may be prevented from being specified to be excluded. That is, if an alignment region R including an edge of the recording medium as a feature point P (hereinafter referred to as an “edge-containing alignment region”) can be set, the edge-containing alignment region may be specified as a first alignment region R1, regardless of the exclusion area RE specified by the second user input.

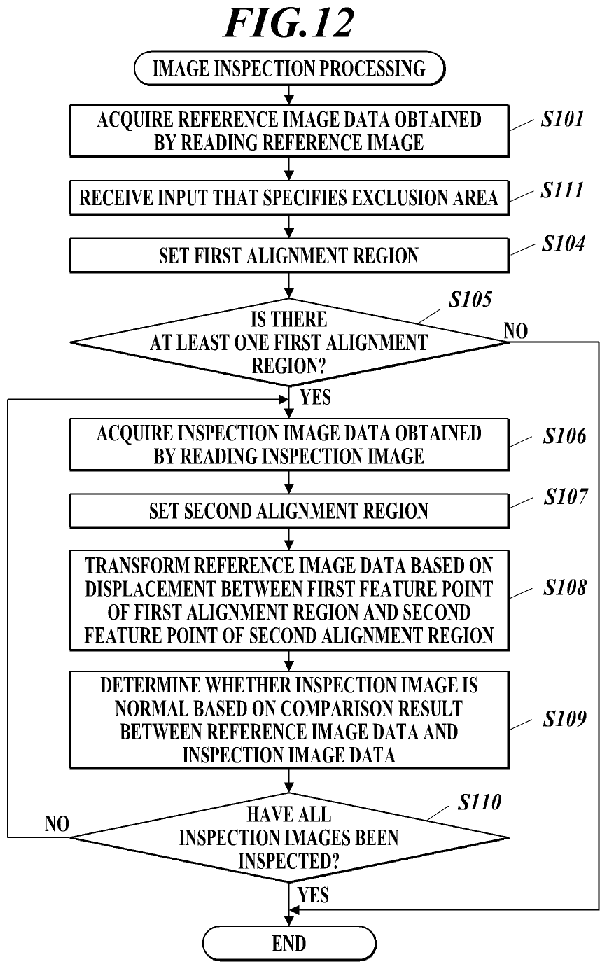

FIG. 12 is a flowchart illustrating the control steps of image inspection processing by the image inspection controller 61 according to the second embodiment.

The flowchart of FIG. 12 corresponds to the flowchart of FIG. 9 with steps S102 and S103 removed and step S111 added.

In the image inspection processing of the present embodiment, after the reference image data is acquired (step S101), the image inspection controller 61 causes the display 15 to display the exclusion setting screen 70, and receives a user input that specifies an exclusion area RE (step S111: second input processing).

After the exclusion area RE is fixed, the image inspection controller 61 sets a first alignment region R1 in the area excluding the exclusion area RE (step S104).

In the present embodiment, steps S111 and S104 correspond to the first setting processing and the first setting step.

The subsequent steps are the same as those of the first embodiment.

As described above, the image inspection controller 61 of the image inspection device 60 according to the second embodiment is configured to further perform second input processing that receives a second user input that specifies the exclusion area RE, and the first setting processing includes setting the first alignment region R1 in an area excluding the exclusion area RE specified by the second user input. Accordingly, the alignment region R in a desired exclusion area RE can be excluded in advance. Also, the processing that sets the temporary alignment regions r can be omitted, so that the image inspection processing can be simplified.

The image inspection controller 61 is configured to further perform display control processing that causes the display 15 to display the image of the reference data image IMGa, and the second user input includes a user input that specifies the exclusion area RE, by selecting a part of the reference data image IMGa displayed on the display 15. Accordingly, the exclusion area RE can be accurately specified, by an intuitive and simple user input that selects the exclusion area RE in the reference data image IMGa.

The first setting processing includes, if an edge-containing alignment region including the edge of the recording medium as the first feature point P1 is settable, setting the edge-containing alignment region as the first alignment region R1, regardless of the exclusion area RE specified by the second user input. Accordingly, even if no feature point P can be specified from an image element (e.g., if the recording medium is blank), alignment and inspection of the image can be performed using the feature point P set at the edge of the recording medium.

The present invention is not limited to the embodiments described above, and various modifications may be made.

For example, images to be inspected are not limited to images formed by variable data printing. The present invention is applicable to inspection of any image that is determined in advance to include an area where a feature point P cannot be specified at a position corresponding to that in a reference image.

In the above embodiments, an example has been described in which a part of the alignment region R is set in the area including an edge of the recording medium. However, the present invention is not limited thereto. The alignment region R may be set only in the area corresponding to the inner side of the recording medium.

Further, an example has been described in which the position model data includes the coordinate data representing the alignment region R and the coordinate data of the feature point P. However, the present invention is not limited thereto. Date representing the number of feature points P included in the alignment region may be used in place of the coordinate data of the feature point P (or in addition to the coordinate data).

In the above embodiments, an example has been described in which print data is generated using a RIP in the external device 2. However, print data may be generated using a RIP in the image forming device 10.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image inspection device comprising: a hardware processor;
wherein the hardware processor performs:
setting a first alignment region including a first feature point of a reference image, based on reference image data of the reference image;
setting a second alignment region including a second feature point of an inspection image that is to be inspected, based on inspection image data obtained by a predetermined reading device reading a recording medium on which the inspection image is formed;
transforming at least one of the reference image data and the inspection image data so as to reduce displacement between the first feature point in the first alignment region and the second feature point in the second alignment region; and
comparing the reference image data and the inspection image data, after the transforming,
wherein setting the first alignment region includes setting the first alignment region in the reference image excluding a specified first exclusion area, and
wherein setting the second alignment region includes setting the second alignment region in the inspection image excluding a second exclusion area corresponding to the first exclusion area.

2. The image inspection device according to claim 1,
wherein the hardware processor further performs:
setting a plurality of temporary alignment regions each including the first feature point, based on the reference image data; and
receiving a first user input that specifies at least one of the plurality of temporary alignment regions as a temporary alignment region to be excluded, and
wherein setting the first alignment region includes setting the first alignment region in the reference image excluding the first exclusion area, by setting each of the plurality of temporary alignment regions excluding the specified temporary alignment region, as the first alignment region.

3. The image inspection device according to claim 2,
wherein the hardware processor further performs: causing a predetermined display device to display the reference image and the plurality of temporary alignment regions, and
wherein the first user input is to select at least one of the plurality of temporary alignment regions displayed on the display device.

4. The image inspection device according to claim 2,
wherein the hardware processor further performs: causing a predetermined display device to display the reference image and the plurality of temporary alignment regions, and
wherein the first user input is to specify a temporary alignment region that is at least partly included in the first exclusion area, by selecting a part of the reference image displayed on the display device as the first exclusion area.

5. The image inspection device according to claim 1,
wherein the hardware processor further performs: receiving a second user input that specifies the first exclusion area, and
wherein setting the first alignment region includes setting the first alignment region in an area excluding the specified first exclusion area.

6. The image inspection device according to claim 5,
wherein the hardware processor further performs: causing a predetermined display device to display the reference image, and
wherein the second user input is to specify the first exclusion area, by selecting a part of the image displayed on the display device.

7. The image inspection device according to claim 1, wherein setting the second alignment region includes setting the second alignment region in the inspection image excluding the second exclusion area, by setting the second alignment region at a position corresponding to the first alignment region.

8. The image inspection device according to claim 1, wherein the reference image data is obtained by the reading device reading a recording medium on which the reference image is formed.

9. The image inspection device according to claim 2,
wherein the reference image data is obtained by the reading device reading a recording medium on which the reference image is formed, the image data representing an area including an edge of the recording medium, and
wherein receiving the first user input includes receiving the first user input that specifies a temporary alignment region from among the plurality of temporary alignment regions each of which includes only a point other than the edge of the recording medium as the first feature point.

10. The image inspection device according to claim 5,
wherein the reference image data is obtained by the reading device reading a recording medium on which the reference image is formed, the image data representing an area including an edge of the recording medium, and
wherein setting the first alignment region includes determining whether an edge-containing alignment region including the edge of the recording medium as the first feature point is settable, and when the edge-containing alignment region is settable, setting the edge-containing alignment region as the first alignment region, regardless of the first exclusion area specified by the second user input.

11. The image inspection device according to claim 1, wherein the reference image data is generated by a raster image processor for a predetermined image forming device to form the reference image on a recording medium.

12. An image forming system comprising:
an image forming device that forms an image on a recording medium;
a reading device that reads the image formed on the recording medium; and
the image inspection device of claim 1.

13. An image inspection method comprising:
setting a first alignment region including a first feature point of a reference image, based on reference image data of the reference image;
setting a second alignment region including a second feature point of an inspection image that is to be inspected, based on inspection image data obtained by a predetermined reading device reading a recording medium on which the inspection image is formed;
transforming at least one of the reference image data and the inspection image data so as to reduce displacement between the first feature point in the first alignment region and the second feature point in the second alignment region; and
comparing the reference image data and the inspection image data, after the transforming,
wherein setting the first alignment region includes setting the first alignment region in the reference image excluding a specified first exclusion area, and
wherein setting the second alignment region includes setting the second alignment region in the inspection image excluding a second exclusion area corresponding to the first exclusion area.

14. A non-transitory recording medium storing a computer-readable program, the program causing a hardware processor provided in an image inspection device to perform:
setting a first alignment region including a first feature point of a reference image, based on reference image data of the reference image;
setting a second alignment region including a second feature point of an inspection image that is to be inspected, based on inspection image data obtained by a predetermined reading device reading a recording medium on which the inspection image is formed;
transforming at least one of the reference image data and the inspection image data so as to reduce displacement between the first feature point in the first alignment region and the second feature point in the second alignment region; and
comparing the reference image data and the inspection image data, after the transforming,
wherein setting the first alignment region includes setting the first alignment region in the reference image excluding a specified first exclusion area, and
wherein setting the second alignment region includes setting the second alignment region in the inspection image excluding a second exclusion area corresponding to the first exclusion area.
